(19) United States
(12) Patent Application Publication
(10) Pub. No.: US 2023/0261324 A1
(43) Pub. Date: Aug. 17, 2023

(54) BREAKABLE SEPARATOR FOR BATTERY

(71) Applicant: SABIC Global Technologies B.V., Bergen op Zoom (NL)

(72) Inventors: Sreekanth Pannala, Sugar Land, TX (US); Nikhil K. E. Verghese, Richmond, TX (US)

(21) Appl. No.: 18/015,274

(22) PCT Filed: Jul. 9, 2021
(86) PCT No.: PCT/EP2021/069228

§ 371 Date: Jan. 9, 2023

(30) Foreign Application Priority Data
Jul. 10, 2020 (IN) 202041029449

(51) Int. Cl. H01M 50/466; H01M 10/0525; H01M 50/507; H01M 10/0583; H01M 50/494; H01M 4/133; H01M 10/44; H01M 10/42

(52) U.S. Cl. CPC H01M 50/466; H01M 4/133; H01M 10/44; H01M 10/0525; H01M 10/0583; H01M 10/4235; H01M 50/494; H01M 50/507

(57) ABSTRACT

The present disclosure includes systems, devices, and methods for operating a battery. The battery includes a power unit having a first electrode coupled to a first current collector and a second electrode. The first current collector is coupled to a first conductive member. The battery further includes a separator having a first portion interposed between the first electrode and the second electrode and a second portion positioned between the second electrode and the first conductive member. In some aspects, the second portion of the separator is configured to break responsive to receipt of a force to the battery to discharge the power unit safely without thermal runaway and catastrophic damage.

### TECHNICAL FIELD

The present disclosure relates generally to battery cells, and more specifically, but not by way of limitation, to a breakable separator for use with rechargeable battery cells.

### BACKGROUND

Batteries are becoming increasingly used to power electronic and mechanical devices in a wide range of applications, such as mobile phones, tablets, personal computers, hybrid electric vehicles, fully electric vehicle and energy storage systems. Specifically, rechargeable batteries, such as Lithium-ion (Li-ion) batteries, have become popular due to several compelling features such as high power and energy densities, long cycle life, excellent storage capabilities, and memory-free recharge characteristics. Rechargeable batteries are designed to offer high power output and to be repeatedly charged and discharged states for long-term use. In larger, more demanding applications, several rechargeable batteries may be connected in series and/or parallel to create a battery pack with higher capacity and power output.

While such batteries and battery packs offer several advantages, these batteries are sensitive to temperature increases, both externally (e.g., from ambient environment) and internally (e.g., heat generated during normal operation of the battery, fast charging and discharging). Serious thermal hazards, such as thermal runaway of the battery and potential explosions of the battery packs, may arise for a variety of reasons. Mechanical impacts of rechargeable batteries and battery packs may cause electrical leaking, poor electrical discharge, short-circuit, or other series of heat release events that lead to thermal runaway. For example, some impacts generate immediate damage, such as a focused short between electrodes, while other impacts may cause gradual damage not immediately noticeable by a user, such as electrical leakage that slowly leads to thermal runaway and destruction of the battery.

### SUMMARY

The present disclosure is generally related to systems, devices, and methods of a separator of a battery cell, module or pack. The separator may be configured to be breakable and to provide temperature control and/or prevent thermal runaway. For example, a system may include a battery cell having a first power unit that includes a first electrode having a first current collector and a second electrode, and a separator. The separator includes a first portion that is interposed between the first electrode and the second electrode and a second portion that is positioned between the second electrode and a first conductive member. The first conductive member may include a portion of the first current collector, a busbar or other conductive structure coupled to the first current collector, a surface of or coating, such as a conductive coating, on a container of the battery cell (e.g., a cell enclosure), or a combination thereof. The second portion of the separator is configured to break responsive to receipt of a force at the battery. For example, the second portion of the separator may have a fracture toughness (K_{Ic}) between 0.2 to 5 MPa·m^{½} such that the second portion is configured to break during a high strain event. The break of the second portion may create a short in the power unit, such as a short between a first current collector associated with the first electrode and a second current collector associated with the second electrode, and allow the battery cell to discharge stored energy safely and prohibit further operation the damaged battery cell. In some such implementations, the second electrode is configured to couple to the first conductive member (e.g., the first busbar or the first current collector) to create an electrical short when the second portion of the separator is broken. The first conductive member is configured to conduct and distribute heat during the electrical short to allow heat and electrical current to easily escape the power unit to ensure safe removal of generated heat preventing focused shorts and thermal runaway possibility. As such, the present systems, devices, and methods, mitigate serious thermal hazards (e.g., thermal runaway, combustion, explosions, and/or the like) which may result from mechanical impacts of conventional batteries.

In some implementations of the present systems, the separator may include a brittle feature such as a notch, brittle coating, UV treatment, or heat treatment. In some such implementations, the fracture toughness of the second portion of the separator is less than or equal to the first portion of the separator. The first electrode may include a first graphite layer, a second graphite layer, and the first current collector. The first current collector includes a first portion that is interposed between the first graphite layer and the second graphite layer. Additionally, in some implementations, the first current collector includes or is unitary with the first conductive member. In some of the foregoing implementations, the second electrode includes a first cathode layer, a second cathode layer, and a second current collection including a first portion interposed between the first cathode layer and the second cathode layer.

In some implementations, the first current collector includes a first portion and a tabbed portion, such as the first conductive member, extending away from the first portion. In some implementations, the tabbed portion extends in a direction substantially parallel to a length of the first busbar. Some of the battery cells may include a second current collector, the second current collector coupled to the second electrode and to a second conductive member. The second conductive member may include a portion of the second current collector, a second busbar or other conductive structure, or a combination thereof. In some implementations, the first busbar and the first electrode include copper and the second busbar and the second electrode includes aluminum. In some implementations of present systems, devices, and methods, the cell includes a container including one or more walls that define a cavity. In some such implementations, the one or more walls include a first wall and a second wall opposite to the first wall, the first busbar may be disposed between the first electrode and the first wall, and/or the second busbar may be disposed between the second electrode and the second wall.

In some implementations of the present systems, the cell includes a second power unit having a third electrode including a third current collector and a fourth electrode including a fourth current collector. In such implementations, the separator may include a third portion interposed between the third electrode and the fourth electrode and a fourth portion positioned between the fourth electrode and the first busbar. The first busbar may be coupled to the third current collector and the second busbar may be coupled to the fourth current collector. Some implementations of the present systems include a battery subpack having two or more battery cells. Each of the battery cells may include the first power unit, the first busbar, and the separator. In some implementations, each battery cell may include the second power unit.

In some implementations of the present systems, devices, and methods include a method of operating the battery cell and receiving a force at the battery, where the force causes the second portion of the separator to break and couple the second electrode to the first conductive member. Coupling the second electrode to the first conductive member may cause an electrical short. Additionally, or alternatively, and the first conductive member and/or a first busbar may conduct heat during the electrical short. Additionally, or alternatively, the force may correspond to an impact with another object or the ground.

As used herein, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, and 10 percent.

The term “about” as used herein can allow for a degree of variability in a value or range, for example, within 10%, within 5%, or within 1% of a stated value or of a stated limit of a range and includes the exact stated value or range. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed implementation, the term “substantially” may be substituted with “within [a percentage] of” what is specified, where the percentage includes 0.1, 1, or 5 percent; and the term “approximately” may be substituted with “within 10 percent of” what is specified. The statement “substantially X to Y” has the same meaning as “substantially X to substantially Y,” unless indicated otherwise. Likewise, the statement “substantially X, Y, or substantially Z” has the same meaning as “substantially X, substantially Y, or substantially Z,” unless indicated otherwise. The phrase “and/or” means and or or. To illustrate, A, B, and/or C includes: A alone, B alone, C alone, a combination of A and B, a combination of A and C, a combination of B and C, or a combination of A, B, and C. In other words, “and/or” operates as an inclusive or. Additionally, the phrase “A, B, C, or a combination thereof” or “A, B, C, or any combination thereof” includes: A alone, B alone, C alone, a combination of A and B, a combination of A and C, a combination of B and C, or a combination of A, B, and C.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1 % to about 5%” or “about 0.1 % to 5%” should be interpreted to include not just about 0.1 % to about 5%, but also the individual values (e.g., 1 %, 2%, 3%, and 4%) and the sub-ranges (e.g., 0.1 % to 0.5%, 1.1 % to 2.2%, 3.3% to 4.4%) within the indicated range. The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus that “comprises,” “has,” or “includes” one or more elements possesses those one or more elements, but is not limited to possessing only those one or more elements. Likewise, a method that “comprises,” “has,” or “includes” one or more steps possesses those one or more steps, but is not limited to possessing only those one or more steps.

Any implementation of any of the systems, methods, and article of manufacture can consist of or consist essentially of - rather than comprise/have/include - any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb. Additionally, the term “wherein” may be used interchangeably with “where”. Further, a device or system that is configured in a certain way is configured in at least that way, but it can also be configured in other ways than those specifically described. The feature or features of one implementation may be applied to other implementations, even though not described or illustrated, unless expressly prohibited by this disclosure or the nature of the implementations.

Some details associated with the implementations are described above, and others are described below. Other implementations, advantages, and features of the present disclosure will become apparent after review of the entire application, including the following sections: Brief Description of the Drawings, Detailed Description, and the Claims.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers.

FIG. 1A is a top cross-sectional view of an example of a battery cell in a first state.

FIG. 1B is a top cross-sectional view of the battery cell of FIG. 1A in a second state after a mechanical impact.

FIG. 2A is a perspective view of an example of a battery cell of the present mechanical impact/electrical/thermal management system.

FIG. 2B is a top cross-sectional view of the battery cell of FIG. 2A in a first state.

FIG. 2C is a top cross-sectional view of the battery cell of FIG. 2A in a second state.

FIGS. 3A-3F are illustrative views of examples of separators of the present thermal management system.

FIG. 4 is a flowchart of an example of a method of operating a battery of the present mechanical impact/electrical/thermal management system.

FIG. 5 is a block diagram of an example of a system for fabricating a battery cell of the present thermal management system.

### DETAILED DESCRIPTION

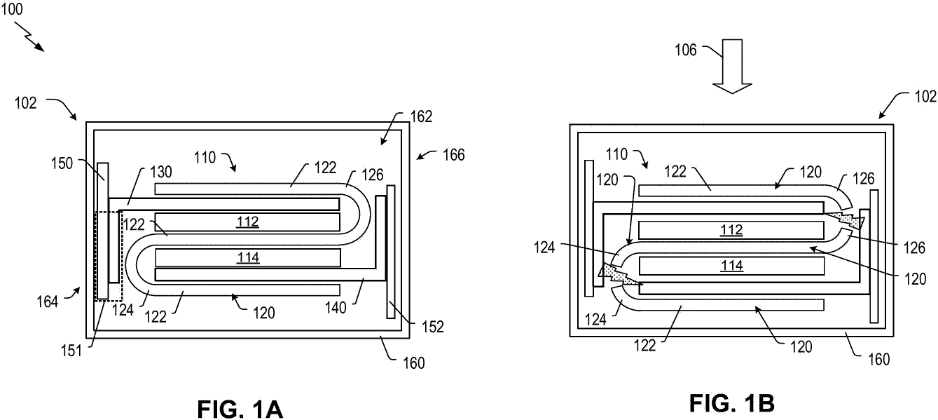

Referring to FIGS. 1A-1B, illustrative views of a mechanical impact/electrical/thermal management system 100 are shown. For example, FIG. 1A shows a top cross-sectional view of mechanical impact/electrical/thermal management system 100 including a battery cell 102 (“cell”) and FIG. 1B shows a top cross-sectional view of the cell in a second state after a mechanical impact. System 100 may be configured to prevent the possibility of thermal runaway due to a mechanical impact by enabling electrical discharge throughout the cell and distribute the heat across the cell.

Cell 102 may include a plurality of power generation units (“power units”) 110 a first busbar 150 and/or a second busbar 152. Each busbar 150, 152 is configured to transfer heat from the power units. Although referred to herein as power units 110, container 100 may also be referred to as a cell sandwich, a jelly roll, or the like. In some implementations, power unit 110 and/or busbars 150 and 152 are disposed within a container 160, such as a cell enclosure, to allow for safe handling of cell 102. Cell 102 may include one more electrical connections (e.g., terminals) configured to be connected (e.g., via wiring or other connections) to one or more electronic devices to provide power to the electronic devices. In some implementations, cell 102 is a rechargeable, or secondary, battery that can be discharged and recharged multiple times. In an illustrative, non-limiting example, battery 102 may be a lead-acid battery, nickel-cadmium (NiCd) battery, nickel-metal hydride (NiMH) battery, lithium-ion (Li-ion) battery, lithium-ion polymer battery, all solid-state lithium-ion battery, and/or the like. Although described as including first and second busbars 150, 152, in other implementations, cell 102 may not include first and second busbars 150, 152. In implementations that do not include first and second busbars 150, 152, functional aspects of the first and second busbars 150, 152 may be realized by the container 160, such as the cell enclosure. To illustrate, the container 160, such as a coating or inner conductive surface of the container 160, may be configured to and distribute heat during the electrical short.

Power unit 110 includes a first electrode 112 (e.g., anode), a second electrode 114 (e.g., cathode), and a separator 120 disposed between the first and second electrodes. Separator 120 may enable ions to pass through the separator between first and second electrodes 112, 114 and prevent the flow of current through the separator. In the depicted implementations, power unit 110 includes a first connector 130 and a second connector 140. The components of power unit 110 may interact to cause an electrical and/or chemical reaction to generate power. For example, first connector 130 (e.g., first current collector) may be configured to transport electrical current from first electrode 112 and second connector 140 (e.g., second current collector) may be configured to transport electrical current from electrode 114. As shown, a conductive member 151 may include at least a portion of first connector 130 (e.g., first current collector), at least a portion of first busbar 150, another conductive structure (e.g., a mesh, a wire, a plate, a fin, a coil, a rigid structure, coating or inner conductive layer of container 160, etc., and/or the like) coupled to first connector 130 and/or first busbar 150, or a combination thereof. The conductive member 151 is configured to create a short between first connector 130 and second connector 140 in the event separator 120 breaks. Additionally, or alternatively, conductive member 151 is configured to distribute (or dissipate) heat from the power unit during operation.

First electrode 112 may include an anode or a cathode and second electrode 114 may include the other of the anode or the cathode. In rechargeable cell sandwiches, the first electrode may alternate between the cathode and the anode based on the state of cell 102. For example, first electrode 112 is the cathode in a discharge state and the anode in a charge state. First and second electrodes 112, 114 may include one or more layers of any suitable material. In an illustrative, non-limiting example, first electrode 112 may include a transition metal oxide layer (e.g., lithium cobalt oxide, lithium iron phosphate, lithium manganese oxide, and/or the like) and second electrode 114 may include a carbon or silicon layer or Li-metal (e.g., graphite, hard carbon, silicon carbon composite, Li-metal anode, and/or the like).

First connector 130 may couple first electrode 112 to first busbar 150 and second connector 140 may couple second electrode 114 to second busbar 152 to provide a low resistance path for electrical current for power unit 110 and to decrease operational and non-uniform temperatures of cell 102 by removing heat through the first and second busbars. First connector 130 may extend from first electrode 112 to first busbar 150 to connect the first electrode to the first busbar, and second connector 140 may extend from second electrode 114 to second busbar 152 to connect the second electrode to the second busbar. First and second connectors 130, 140 may include a thermally conductive material, such as aluminum, gold, copper, silver, tungsten, zinc, alloys, structured carbon (fiber, nanotubes, graphene, etc.), fiber-reinforced composite, or combinations thereof, and/or the like, to conduct electrical current and transfer heat away from power unit 110. Although described herein as separate components, first connector 130 and electrode 112, and/or second connector 140 and electrode 114 may be a single unitary component (e.g., fiber reinforced composite having an active material and conductive fibers).

Separator 120 includes at least one body portion 122 and one or more end portions (e.g., 124). For example, separator 120 may include a first end portion 124 and a second end portion 126 coupled to opposing ends of body portion 122. As shown, body portion 122 is positioned between (e.g., interposed between) first electrode 112 and second electrode 114 to provide a barrier (e.g., insulate and/or prevent a short circuit) between the first electrode 112 and the second electrode 114 during operation of cell 102. In such implementations, first end portion 124 is positioned between second electrode 114 and first conductive member 151 (e.g., first busbar 150). Additionally, or alternatively, second end portion 126 is positioned between first electrode 112 and a second conductive member (e.g., second busbar 152, second connector, another conductive structure, or a combination thereof). As shown in FIG. 1A, body portion 122 is planar and first end portion 124 extends away from an end of body portion 122. In some implementations, at least a segment of first end portion 124 extends in a direction that is substantially perpendicular to body portion 122. First end portion 124 may define a segment of separator 120 that connects an end of body portion 122 to another component (e.g., another body portion 122, container 160, a busbar, or the like). For example, in the implementation shown in FIG. 1A, first end portion 124 extends between two distinct body portions (e.g., 122). In some implementations, first end portion 124 defines an arcuate surface having a U shaped cross-section, while in other implementations, the first end portion may define any suitable shape, whether straight, curved, undulating (e.g., zig-zag), or the like. Second end portion 126 may extend from an end of body portion 122 that is opposite first end portion 124 and may extend in a direction opposite of the first end portion.

The end portions 124, 126 are configured to exhibit relatively small plastic deformation such that the first end portion may absorb only a small amount of energy prior to fracture. For example, end portions 124, 126 may have a fracture toughness (K_{Ic}) between 0.2 to 5 MPa·m^{½}. The fracture toughness of each end portion (e.g., 124, 126) may be greater than or substantially equal to any one of, or between any two of: 0.2, 0.3, 0.4, 0.5, 0.55, 0.6, 0.65, 0.7, 0.75, 0.8, 0.85, 0.9, 0.95, 1.0, 1.1, 1.2, 1.3, 1.4, 1.5, 2.0, 2.5, 3.0, 3.5, 4.0, 4.5, or 5 MPa·m^{½} (e.g., such as between 0.2 to 0.75 MPa·m^{½}). Fracture toughness can be measured using standard ASTM derived protocols (e.g., ASTM D5045 using specimen geometries such as compact tension or single edge notch bend, Essential Work of Fracture method for fracture toughness of thin membranes transition from plane strain to plane stress conditions¹ or the like). In an illustrative implementation, end portions 124, 126 may have a fracture toughness that is less than 90% of the fracture toughness of body portion 122, such as, for example, a fracture toughness of less than 75%, 50%, or 30% of the fracture toughness of the body portion. In this way and others, portions of separator can be ductile enough for assembly and regular operations, but brittle enough to fracture at high strain conditions.

¹ Y-W Mai and B. Cotterell, Engng. Fract. Mech., 21, 123 (1985); Y-W Mai and B. Cotterell, Int. J. Fract., 32, 105 (1986).

In some implementations, first end portion 124 and/or second end portion 126 may include a material different from body portion 122. For example, separator 160 may be made by striping two materials to form the separator and assembling (e.g., folding) the separator within cell 102 so that one material is aligned with end portions 124, 126 and the other material aligns with body portion 122. In some implementations, cell 102 may include one or more brittle features to enable the end portions to have a sufficiently low fracture toughness (e.g., less than 10 MPa·m^{½}) to induce a fracture at the end portions. In some implementations, the brittle feature may include one or more layers of material disposed on (e.g., coating) end portions 124, 126 to reduce fracture toughness of the end portions. The one or more layers may include a ceramic, a polyolefin, another material, or the like, as illustrative, non-limiting examples. In some implementations, brittle feature may include one or more notches (e.g., indentation) defined at end portions 124, 126 to initiate crack propagation at the end portions. In some implementations, end portions 124, 126 may be treated (e.g., thermal, ultraviolet (UV), or other treatment) to increase chance of fracture. Additionally, or alternatively, one or more other components of cell 102 may include features to induce fracture at end portions 124, 126. To illustrate, first busbar 150 and/or second busbar 152, first connector 130 and/or second connector 140, first conductive member 151 and/or a second conductive member, the container 160, such as a coating or inner conductive surface 161 of the container 160, or a combination thereof, may include edges (e.g., corrugations, spike, prong, or other projection) configured to pierce end portions 124, 126 during a collision. As a result, end portions 124, 126 are brittle and have relatively high-stiffness such that the end portions are configured to break responsive to receipt of a force (e.g., 106) associated with an impact of cell 102.

In some of the foregoing implementations, the brittle features may be formed after assembly of power unit 110 (and before final formation of cell 102) to prevent unintentional fracture of end portions during formation of the power unit. To illustrate, separator 160 may start as a planar member that is folded over electrodes (e.g., 130, 112 and/or 140, 114). As such, end portions need to have ductility during assembly and also normal operations (to accommodate change in electrode volume upon charge and discharge), yet have brittleness to fracture during when subjected to high strain rate event such as a collision. In some such implementations, coating end portions 124, 126, treating the end portions or forming a notch in the end portions is performed after assembly.

In some implementations, separator 120 may be a single layer of film or a multi-layer film made of polymeric materials. Separator 120 may include an electrolyte such as, for example, a lithium salt in an organic solvent, a water-based electrolyte, a mixture of organic carbonates (e.g., ethylene carbonate or diethyl carbonate), aqueous electrolytes, composite electrolytes, solid ceramic electrolytes, solid polymer electrolytes, and/or the like.

First busbar 150 and second busbar 152 are positioned adjacent to power unit 110 to further distribute heat from the power unit and to direct current generated by the power unit. For example, first busbar 150 may be interposed between power unit 110 and container 160 to direct heat toward the exterior of cell 102 where it may be more readily distributed (or dissipated) by external cooling components. In some implementations, first busbar 150 may be positioned substantially perpendicular to first electrode 112 and/or first connector 130. First busbar 150 may span at least a portion (e.g., at least 30%) of the power unit 110 to provide increased thermal conductivity along a plane perpendicular to first electrode 112. Second busbar 152 may be positioned similarly to first busbar 150. For example, second busbar 152 may be substantially parallel to first busbar 150 to remove heat along a plane parallel to the first busbar. Each busbar (e.g., 150, 152) may include a suitable highly thermally conductive material such as aluminum, gold, copper, silver, tungsten, zinc, carbon (e.g., graphite, fiber, graphene, nanotubes), alloys thereof, and/or the like. In some implementations, first busbar 150, second busbar 152, first connector 130, and second connector 140 have a thermal conductivity greater than or equal to 30W/(mK). Additionally, or alternatively, first connector (e.g., 130) may include the same material as first busbar (e.g., 150) to ensure electrochemical compatibility. To illustrate, first busbar 140 and first connectors 130 may include aluminum or an aluminum alloy and second busbar 150 and second connectors 140 may include copper or a copper alloy. In some implementations, first busbar 150 and first connector 130 are a single, unitary component, second busbar 152 and second connector 140 are a single, unitary component, or a combination thereof. Additionally, or alternatively, first busbar 150, second busbar 152 may be non-conductively coupled to container 160.

Container 160 defines a cavity 162 and includes a first side 164 (e.g., first wall) and a second side 166 (e.g., second wall). First side 164 is opposite second side 166 and each side cooperates to define at least a portion of cavity 162. Container may also have an inner surface 161, such as an inner conductive surface or a coated surfaced (e.g., a conductive coating). Container 160 may include a rigid, semi-rigid or flexible material and may be shaped in any suitable manner (e.g., cylindrical, prismatic, or the like) based on the desired application of cell 102. In some implementations, container 160 may correspond to a rectangular prism, which may enable cell 102 to be utilized in applications where a small, high-powered battery is required. Power unit 110, busbars (e.g., 150, 152), and other components of cell 102 may be disposed within cavity 162. In this way, container 160 may provide an insulative protective casing around power unit 110. Additionally, or alternatively, busbars 150, 152 and/or one or more conductive members (e.g., 151) may prevent electrical accidents or damage that may arise from handling cell 102.

In the implementation shown in FIGS. 1A and 1B, separator 120 is configured to fracture upon application of a force or impact 106. In some implementations, cell 102 (e.g., container 160) may be compressible upon application of force 106 so that one or more components of power unit 110 (e.g., first connector 130, first electrode 112, separator 120, second electrode 114, and/or second connector 140) are compressed at the point of impact with compressive forces closer to the impact and tensile forces away from the impact. Such an application of force 106 may cause first end portion 124 and second end portion 126 to fracture (e.g., break apart). As a result, first end portion 124 is severed into multiple discrete segments—such as two segments as illustrated in FIG. 1B. Additionally, or alternatively, second end portion 126 may fracture into two or more discrete segments. The resulting fractures of first end portion 124 and second end portion 126 create shorts in power unit 110 to discharge the power unit safely by reducing the chance for thermal runaway. For example, the fracture of first end portion 124 enables continuous contact between first connector 130 and a second conductive member (e.g., second busbar 152 and/or second connector 140) coupled to the second connector 140, and/or between second connector 140 and first conductive member 151 to uniformly discharge the power unit. High thermal conductivity of these components will ensure safe removal of heat generated from the shorts preventing focused shorts and thermal runaway possibility. In this manner, thermal runaway is prevented along with combustion and over pressurization (e.g., explosion) of cell 102.

Force 106 may correspond with an impact of cell 102 with another component or the ground. Such an impact may be greater than or equal to 500 Newtons. For example, the battery pack may be subjected to a typical force of 500 kN on side crush and 200 kN on frontal crash and this force is distributed among the cells based on the battery pack/module/cell design, pack enclosure and structural elements. In some implementations, force 106 may generate a tensile force acting on the first end portion and/or second end portion.

In an illustrative implementation, cell 102 includes a first power unit 110 having a first electrode 112 coupled to a first current collector 130 and a second electrode 114, a first conductive member 151 coupled to the first current collector, and a separator 120 having a first portion (e.g., 122) interposed between the first electrode and the second electrode and a second portion (e.g., 124) positioned between the second electrode and the first conductive member 151. In such an implementation, the second portion (e.g., 124) of separator 120 is configured to break responsive to receipt of a force (e.g., 106) at cell 102.

In the foregoing implementations, separator 120 may operate to uniformly discharge cell 102 in a safe manner, preventing focused shorts and thermal runaway. For example, first end portion 124 or second end portion 126 are configured to fracture upon an impact (e.g., 106) to cell 102. This enables coupling of collectors to create a minor short that will discharge the power unit without damage to surrounding components. For example, in some implementations, collectors may be coupled with busbars to create the minor short. Additionally, the electrical short will prevent further charging and discharging to notify an operator that the cell is damaged. In this manner, cell 102 prevents operators from unknowingly using partial damaged batteries that have an increased risk of thermal runaway.

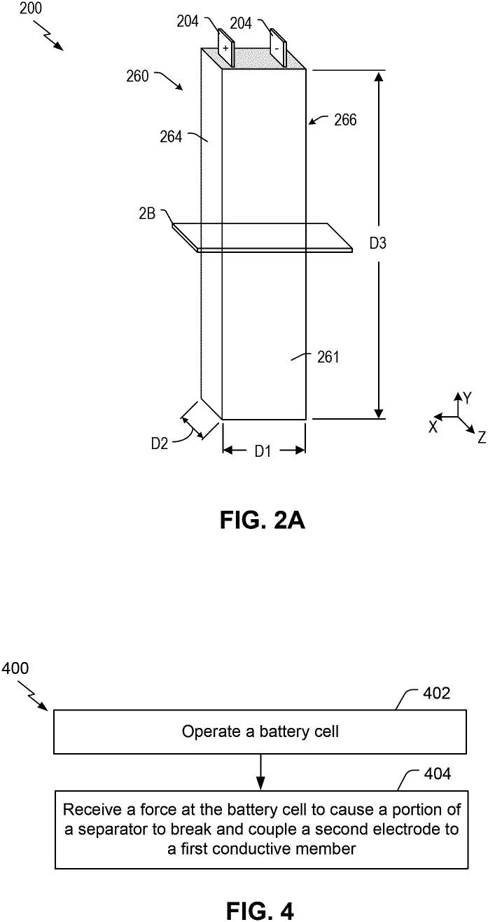

Referring to FIGS. 2A-2C, examples of a cell 202 of a mechanical impact, electrical, and thermal management system 200 are shown. FIG. 2A shows a perspective view of cell 202 and FIGS. 2B and 2C show a cross-sectional view of the cell taken along plane 2B. Cell 202 may include or correspond to cell 102. For example, cell 202 includes a plurality of power units 210, a first busbar 250, and a second busbar 252 disposed within a container 260. The power units 210, first busbar 250, second busbar 252, and container 260 may include or correspond to power units 110, first busbar 150, second busbar 152, and container 160, respectively. Although described as including busbars 150, 152, in other implementations, the cell 202 may not include busbars 150, 152.

As shown in FIG. 2A, cell 202 may include one more electrical connections 204 (e.g., terminals) configured to be connected (e.g., via wiring or other connections) to one or more electronic devices (not shown) to provide power to the electronic devices. As shown, electrical connections 204 include a pair of electrode terminals configured to provide electrical current to a device when the device is coupled to the terminals. For example, a first terminal (e.g., 204) corresponds to a positive terminal and a second terminal (e.g., 204) corresponds to a negative terminal. Although only a single cell (e.g., 202) is depicted, some implementations of the mechanical impact, electrical, and thermal management system 200 include a plurality of batteries (e.g., 202) coupled together in a cell pack and may include one or more additional components (e.g., circuit board, processor, controller, wiring, conductor, resistor, terminal block, electrode terminals, and/or the like). In some implementations, the first terminal (e.g., 204) is coupled to a first busbar (e.g., 150) and the second terminal (e.g., 204) is coupled to a second busbar (e.g., 152).

By way of illustration, cell 202 is described with reference to a right handed coordinate system, as shown in FIG. 2A, in which the x-axis corresponds to a left-right direction of the page, the y-axis corresponds to an up-down direction on the page, and the z-axis corresponds to an axis that travels orthogonally into or out of the page. Container 260 has a width D1, a thickness D2, and a length D3, each of which may be measured along a straight line from opposing sides (e.g., walls) of container 260. As shown in FIG. 2A, width D1 is measured along the x-axis, thickness D2 is measured along the z-axis, and length D3 is measured along the y-axis. In the depicted implementation, thickness D2 may be greater than (e.g., 10% greater than) width D1, however, in other implementations, width D1 may be substantially equal to thickness D2 (e.g., cuboid), and, in yet other implementations, width D1 may be greater than thickness D2.

Container 260 includes one or more walls 261, a first side 264, and a second side 266 that is opposite to the first side. Walls 261 cooperate to define a cavity 262 in which components of cell 202 may be stored. In some implementations, first side 264 and second side 266 correspond to a first wall and second wall, respectively, of the one or more walls 261. In the depicted implementations, container 260 is prismatic (e.g., cuboid, rectangular prism) and includes four walls (e.g., 261), yet, in other implementation, container 260 may be sized and shaped based on an application of cell 202. For example, a cross-section of container 260 may be rectangular (as shown in the implementations of FIGS. 2B and 2C) triangular, pentagonal, hexagonal, or otherwise polygonal (whether having sharp and/or rounded corners), circular, elliptical, or otherwise rounded, or can have an irregular shape.

Referring now to FIGS. 2B and 2C, a top sectional view of cell 202 taken about plane 2B is shown in a first state and a second state, respectively. As shown, the right handed coordinate system is rotated such that the x-axis corresponds to a left-right direction of the page, the z-axis corresponds to an up-down direction on the page, and the Y-axis is not illustrated as it extends into and out of the page.

Cell 202 depicted in FIG. 2B includes a first busbar 250, a second busbar 252, and a plurality of power units 210 each having a first electrode 212, a first connector 230 (e.g., first current collector), a separator 220, a second electrode 214, and a second connector 240 (e.g., second current collector). Although described as including busbars 250, 252, in other implementations, busbars 250, 252 may be omitted from cell 202. Additionally, or alternatively, cell 202 may include one or more conductive members, such as conductive member 151 as described with reference to FIGS. 1A and 1B. First electrode 212 is coupled to first connector 230 and second electrode 214 is coupled to second connector 240 to create an electrical pathway to enable current to flow through cell 202 when the cell generates power. In some implementations, power units 210 may share one or more components to decrease the volume of the power unit and allow cell 202 to be more compact. For example, a single first connector (e.g., 230) may be utilized as the first connector for two adjacent power units. In such implementations, the first connector (e.g., 230) is interposed between two layers of first electrode (e.g., 212). To illustrate, each power unit 210 may be aligned (e.g., along the Z axis, as shown in FIG. 2A) with one other power unit such that the power units form a stack. For example, each power unit 210 may be prismatic (e.g., include a rectangular cross-section) and disposed adjacent to one other power unit to enable multiple power units to be positioned within a small space (e.g., 262). As shown in FIG. 2B, cell 202 includes five power units 210 disposed in the stack; however, in other implementations, cell 202 may include less than five power units (e.g., 1, 2, 3, or 4 power units) or more than five power units (e.g., greater than, equal to any one of, or between any two of: 6, 8, 10, 12, 18, 24, 30 or more power units).

First connector 230 may include a body 232 (e.g., first portion) and a tab 234 (e.g., second portion) that extends away from the body. Although described as and referred to as tab 234, in other implementation, tab 234 may include or correspond to a conductive member (e.g., 151). In other implementations, tab 234 may be omitted. Body 232 is coupled to (e.g., in contact with) first electrode 212 to transport an electrical charge as power unit 210 charges and discharges. To illustrate, body 232 may extend in a direction parallel to first electrode 212 and, in some implementations, the body may span (or cover) approximately an entirety of the first electrode 212 (e.g., a surface area of the body is greater than a surface area of the first electrode). In implementations, with a plurality of power units (e.g., 210), body 232 may be interposed between a first layer of active material (e.g., 212) and a second layer of active material (e.g., 212) such that a single connector (e.g., 230) may direct current produced by two adjacent power units (e.g., 210). Tab 234 is angularly disposed relative to (e.g., perpendicular to) body 232 to distribute heat generated from first electrode 212 in a plane that is angularly disposed to the body. In some implementations, tab 234 may extend in a direction that is substantially parallel to first busbar 250 (e.g., length of the tab is parallel to a length of the first busbar). Tab 234 is coupled to (e.g., in contact with) first busbar 250 to deliver electrical current to the first busbar and to distribute heat generated from power unit 210 to the first busbar.

Second connector 240 may include one or more features similar to first connector 230. For example, second connector 240 includes a body 242 (e.g., first portion) and a tab 244 (e.g., second portion) that extends away from body 242. Although described as and referred to as tab 244, in other implementation, tab 244 may include or correspond to a conductive member (e.g., 151). In other implementations, tab 244 may be omitted. As shown in FIG. 2B, body 242 is in contact with one or more second electrodes 214 and tab 244 is in contact with second busbar 252 to distribute current and distribute heat generated by power unit 210 to the second busbar. For example, body 242 may be interposed between a first cathode layer (e.g., 214) and a second cathode layer (e.g., 214).

As shown, separator 220 may include a Z-folded separator 220 having a unitary body that extends through each power unit 210 such that a portion of the separator is disposed between first electrode 212 and second electrode 214 of each power unit. In such implementations, separator 220 includes a plurality of body portions 222 and a plurality of end portions (e.g., 224, 226) that extend between each body portion. For example, as depicted in FIG. 2B, separator 220 includes a first end portion 224 that extends from one end of the body portions and a second end portion 226 that extends from the other end of the respective body portions. Each body portion 222 may be shaped similar to first and second electrodes 212, 214 (e.g., planar) such that the body portions may be interposed between the first and second electrodes 212, 214 to selectively permit particles travelling between the first and second electrodes. In some implementations, at least a segment of first end portions 224 extend in a direction that is substantially perpendicular to body portions 222 to connect adjacent body portions.

In some implementations, first end portion 224 is positioned between second connector 240 and first busbar 250 (or a conductive member (e.g. 151)). Additionally, or alternatively, first end portion 224 may be positioned between second connector 240 (e.g., body 242) and first connector 230 (e.g., tab 234). In this manner, first end portions 224 may prevent electrical current from flowing between second connector 240 and first busbar 250. As a result, separator 220 may prevent electrical shorts and/or electrical leakage within cell 202. Additionally, or alternatively, second end portion 226 is positioned between first connector 230 and second busbar 252 to prevent an electrical short.

Referring to FIG. 2C, a top cross-sectional view of cell 202 is shown in a second state, in which a portion of separator 220 has fractured. Such a fracture may be caused by a force 206 acting on cell 202. Separator 220 may be brittle to prompt fracture of first end portion 224 and/or second end portion 226 after being subjected to force 206. In this manner, electrical current is able to flow between second electrode 214 and first busbar 250 to create an electrical short that enables cell 202 to discharge the power units 210 safely without thermal runaway and explosion. Consequently, serious thermal hazards (e.g., thermal runaway, combustion, explosions, and/or the like) typically associated with mechanical impacts of traditional secondary batteries may be avoided.

First and second end portions 224, 226 are configured to break responsive to receipt of force 206 at cell 202. For example, first end portions 224 and/or second end portions 226 may have a fracture toughness (K_{Ic}) between 0.2 to 5 MPa·m^{½}. In some implementations, first and second end portions 224, 226 have a fracture toughness (K_{Ic}) between 0.2 to 5 MPa·m^{½}. For example, at least a segment (e.g., a portion) of each first end portion 224 may have a fracture toughness (K_{Ic}) between 0.2 to 5 MPa·m^{½}. In this way and others, separator 260 yields at the edges (e.g., 224, 226) so that there is shorting all over cell 202 and thus the cell may distribute the energy stored in a safe manner without a thermal runaway incident. In some such implementations, power units 210 may include one or more brittle features to enable the end portions to have a sufficiently low fracture toughness (e.g., less than 10 MPa·m^{½}). For example, first end portion 124 and/or second end portion 126 may define a notch or indentation, may include one or more layers (e.g., coats) of material, may be treated (e.g., thermal, ultraviolet (UV)), or a combination thereof. In some implementations, first busbar 150 and/or second busbar 152, tab 234 and/or tab 244, one or more conductive members (e.g., 151), or a combination thereof, may include sharp edges (e.g., corrugations, spike, prong, or other projection) configured to pierce end portions 124, 126 during a collision.

As shown in FIG. 2C, first end portions 224 and second end portions 226 may fracture, however, in other implementations, only one of first end portions 224 and second end portions 226 is configured to fracture. In yet other implementations, only a fraction (e.g., less than the entirety) of first end portions 224 and/or second end portions 226 are configured to fracture.

In some implementations, first and second end portions 224, 226 may define at least one curve to provide a weak point along separator 220. As shown in FIG. 2C, end portions 224, 226 define a single U-shaped curve, however, the end portions may define a plurality of curves (e.g., zig-zag), or may be otherwise shaped so that force 206 causes separator 220 to fracture at the end portions. In this manner, receipt of force 206 at any orientation relative to cell 202 causes separator 220 to fracture at end portions 224, 226 rather than body portions 222. Accordingly, cell 202 may prevent focused shorts (e.g., between first and second electrodes 212, 214) and reduce (or eliminate) the possibility of thermal runaway due to gradual electrical leakage.

Separator 220 may include an electrolyte such as, for example, a lithium salt in an organic solvent, a water-based electrolyte, a mixture of organic carbonates (e.g., ethylene carbonate or diethyl carbonate), aqueous electrolytes, composite electrolytes, solid ceramic electrolytes, solid polymer electrolyte, and/or the like to prevent current from passing between the separator and causing an electrical short.

In the implementation shown in FIGS. 2A and 2B, cell 202 (e.g., container 260) may be compressible upon application of force 206 so that one or more components of power units 210 are squeezed together. In other implementations, container 260 may be rigid and separator 220 may be positioned within cavity 262 to break upon receipt of force 206. In some of the foregoing implementations, separator 220 is positioned within container 260 such that a mechanical impact will transfer a force (e.g., compressive, tensile, shear, etc.) to the separator, or a component coupled to the separator, to generate a failure at several different points along the separator. In this manner, a mechanical impact will cause a failure at several locations, allowing the current to discharge at the several locations rather than discharging at a single location which causes local heating, increased temperature and thermal runaway. For example, each end portions 224. 226 may be severed into at least two discrete segments—as illustrated in FIG. 2C. The resulting fractures enable current flow between first connector 230 and second busbar 252 and/or current flow between second connector 240 and first busbar 250 and/or tab 234 to uniformly discharge the power unit, preventing focused shorts and minimizing the risk of thermal runaway. In this manner, thermal runaway is prevented along with combustion and over pressurization (e.g., explosion) of cell 202.

In an illustrative implementation, cell 202 includes a first power unit 210 having a first electrode 212 coupled to a first current collector 230 and a second electrode 214, a first conductive member coupled to the first current collector, and a separator 220 having a first portion (e.g., 222) interposed between the first electrode and the second electrode and a second portion (e.g., 224) positioned between the second electrode and the first conductive member (e.g., 151). In such an implementation, the second portion (e.g., 224) of separator 220 is configured to break responsive to receipt of a force (e.g., 206) at cell 202. In yet another illustrative implementation, thermal management system 200 includes a battery subpack having two or more batteries (e.g., 202). At least one of the two or more batteries (e.g., 202) include a first power unit 210 having a first electrode 212 coupled to a first current collector 230 and a second electrode 214, a first conductive member (e.g., 151) coupled to the first current collector, and a separator 220 having a first portion 222 interposed between the first electrode and the second electrode and a second portion (e.g., 224) positioned between the second electrode and the first conductive member. In such implementations, the second portion (e.g., 224) of separator 220 is configured to break responsive to receipt of a force (e.g., 206) at cell 202.

In the foregoing implementations, separator 220 may operate to uniformly discharge cell 202 in a safe manner, preventing focused shorts and thermal runaway. For example, first end portion 224 or second end portion 226 are configured to fracture upon an impact (e.g., 206) to create a minor short of the power units 210 that discharges the power units without damage to surrounding components. In this manner, impact to a battery pack may be contained to the batteries (e.g., 202) that are actually damaged. The damaged batteries may then be replaced and the risk of unknown partially damaged batteries remaining in the battery pack—which may later combust or explode—is minimized.

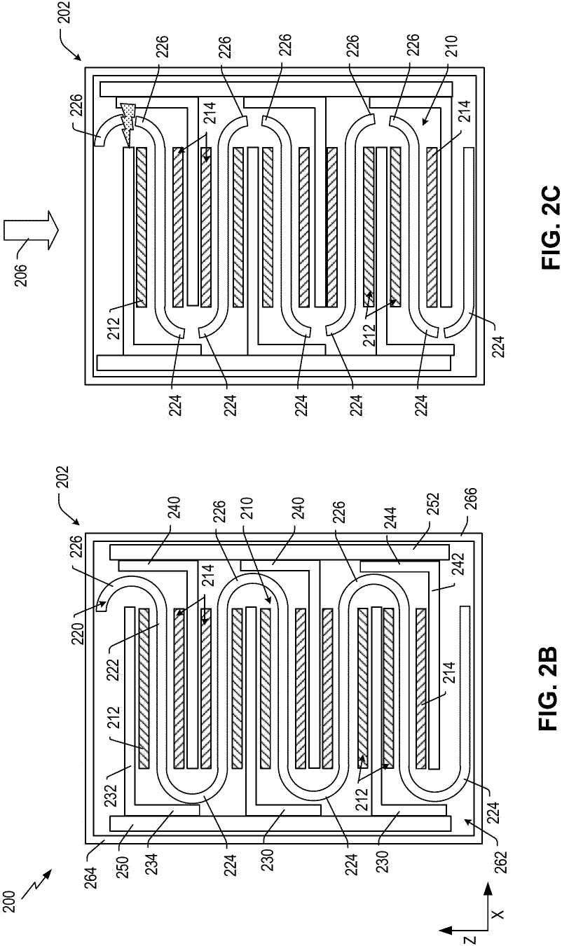

Referring now to FIGS. 3A-3F, various examples of separators 320 associated with a thermal management system are shown. Separators 320 may include or corresponds to separators 120, 220. Separators 320 include a body portion 322 and an end portion 324. End portion 324 and body portions may include or correspond to end portions 124, 126, 224, 226 and body portions 122, 222, respectively. Additionally, separator includes a first surface 373 and a second surface 374 that is opposite the first surface 373. In some implementations, an interface 325 may be present between body portion 322 and end portion 324.

As shown in FIG. 3A, separator 320 may be striped and include a first material 370 and a second material 372. First material 370 may be positioned between two portions of second material 372 such that when separator 320 is assembled (e.g., folded) end portion 324 includes the first material and body portions 322 include the second material. In some implementations, first material 370 includes a lower fracture toughness than second material 372. First material 370 may include a material that is ductile enough to remain intact during assembly, but brittle enough to fracture during an impact, as described herein. In some implementations, first material 370 may include a ceramic. Additionally, or alternatively, first material 370 may be a different material from second material 372 and may have a coating applied thereto as described at least with reference to FIG. 3B and/or may be subject to treatment as described at least with reference to FIG. 3C.

Referring to FIG. 3B, end portion 324 may include a coating 376. In some implementations, coating may, but need not be, applied after assembly of separator 320. Coating 376 may include a suitable material that lowers the fracture toughness of end portion 324. As shown, coating 376 may be disposed on an entirety of end portion 324, however, in other implementations, the coating may only span a segment of the end portion. In some implementations, such as that shown in FIG. 3C, end portion 324 may be subjected to treatment (e.g., chemical treatment, radiation treatment, or the like). For example, end portion 324 may be thermally treated, UV treated, or the like. In the depicted implementation, a treatment device 378 may apply radiation (e.g., ultraviolet light), heat (e.g., convective heat), one or more chemicals (e.g., coating 376) to end portion 324 to reduce fracture toughness of the end portion. Treatment device may comprise any suitable device known in the art. In some implementations, coating 376 or treatment of end portion 324 (e.g., via device 378) is performed after assembly to enable separator 320 to be assembled without damage to the end portion while still enabling fracture of the end portion during an impact of the cell (e.g., 102, 202). Although shown as being applied to an outer surface of end portion 324, coating 376 and/or treatment of the end portion may be applied to an inner surface of the end portion, any other surface of the end portion (e.g., side surfaces), or combination thereof.

As shown in FIGS. 3D and 3E, one or more components of the cell (e.g., 102, 202) may define a brittle feature. In the implementation shown in FIG. 3D, end portion 324 may define a notch 382 (e.g., indentation) that is configured to initiate crack propagation during an impact. Although two notches 382 are depicted, other implementations of separator 320 have end portions 324 that define single notch (e.g., 382) or three or more notches (e.g., 382). Notch 382 may be defined on end portion 324 at an outer surface, an inner surface, any other surface, or combination thereof. In some implementations, a tip may be a v-notch or a chevron v-notch with a tip having an edge, such as a sharp tip. Additionally, or alternatively, a notch may have a depth that is less than or equal to 50% of a thickness of a separator and may be configured to avoid pre-mature failures. For example, if a separator has a thickness of 10 microns, the notch may have a depth of less than or equal to 5 microns. As another example, if a separator has a thickness of 15 microns, the notch may have a depth of less than or equal to 7.5 microns. In some implementations, other components of the cell (e.g., 102, 202) may include a brittle feature to enable fracture of end portion 324. For example, as shown in FIG. 3E, a conductive member 350, such as conductive member 151, may define one or more projections 384 configured to contact end portion 324 to initiate crack propagation. Projections 384 (e.g., corrugations) include a sharp edge to rupture end portion 324 when conductive member 350 is pressed against the end portion. Conductive member 350 may include or correspond to first or second busbar 150, 152, 250, 252, connectors 130, 140, 230, 240, tabs 234, 244, container 160, 260, a surface of or coating on a surface of container 160, 260, a non-conductive structure, or a combination thereof. Notches 382 and/or projections 382 may be formed after assembly of separator 320 to enhance the chance of fracture without increasing chance of damage during assembly.

Referring to FIG. 3F, examples of different notches of separator 320 are shown. Separator 320 includes first surface 373, second surface 374 (opposite first surface 373), third surface 385, fourth surface 386 (opposite third surface 385), fifth surface 387, and sixth surface 388 (opposite fifth surface 387). Although shown as having six surfaces, in other implementations, separator may include more than six surfaces or fewer than six surfaces. Additionally, although described as surfaces, in other implementations, each of 373, 374, 385-388 may refer to a side (e.g., a relative side) of separator 320.

Separator 320 may include one or more notches 389-393. At least one of the one or more notches 389-393 may include or correspond to notch 382. Notches 389, 390 may be formed in first surface 373 and may extend from fifth surface 387 to sixth surface 388. As shown, notch 389 defines a rounded or U-shaped groove or channel and notch 390 defines a V-shaped groove or channel. In other implementations, notch 389, 390 may have another geometry and/or define a different shaped groove. Additionally, or alternatively, notch 389, 390 may extend from the fifth surface 387 toward, but not all the way to, the sixth surface 388. It is also noted that notch 389, 390 may be positioned between, but not extending to either of fifth surface 387 and sixth surface 388.

Notch 391 is formed at an edge between first surface 373 and fifth surface 387. Notch 392, 392 are formed on fifth surface 387. A set of one or more notches 394 is formed on first surface 373. When the set 394 includes multiple notches, two or more of the notches may be the same size (e.g., have the same dimensions) or may be different sizes. In some implementations, each notch of the set of multiple notches is a different size. The notches may be sized and positioned or placed to promote breakage of separator responsive to at least a threshold amount of force. Although FIG. 3F is shown as having multiple different types of notches 389-394, in other implementations, separator 320 may have a single notch type or any combination of notch types. Additionally, although notches 389-394 have been described with reference to specific surfaces (or sides), in other implementations, each of notches 389-394 may be formed with reference to a different surface (or side).

In some implementations, one or more aspects of FIGS. 3A-3F may be combined with one or more aspects of at least another one of FIGS. 3A-3F. For example, coating 376 on separator 320 of FIG. 3B may be used in combination with protrusions 384 of FIG. 3E. As another example, any of notches 389-394 may be included or defined by separator 320 of any of FIGS. 3A-3E. Additionally, any of the notches may be formed on boy portion 322, end portion 324, or a combination thereof. As another example, notches 382 of FIG. 3D may be formed after folding and may include one or more of notches 389-394. Additionally, or alternatively, after forming notches 382, coating 376 and/or treatment 378 may be applied/performed. To illustrate, coating 376 may be applied and then treatment 378 may be performed. Alternatively, treatment 378 may be performed and then coating 376 may be applied.

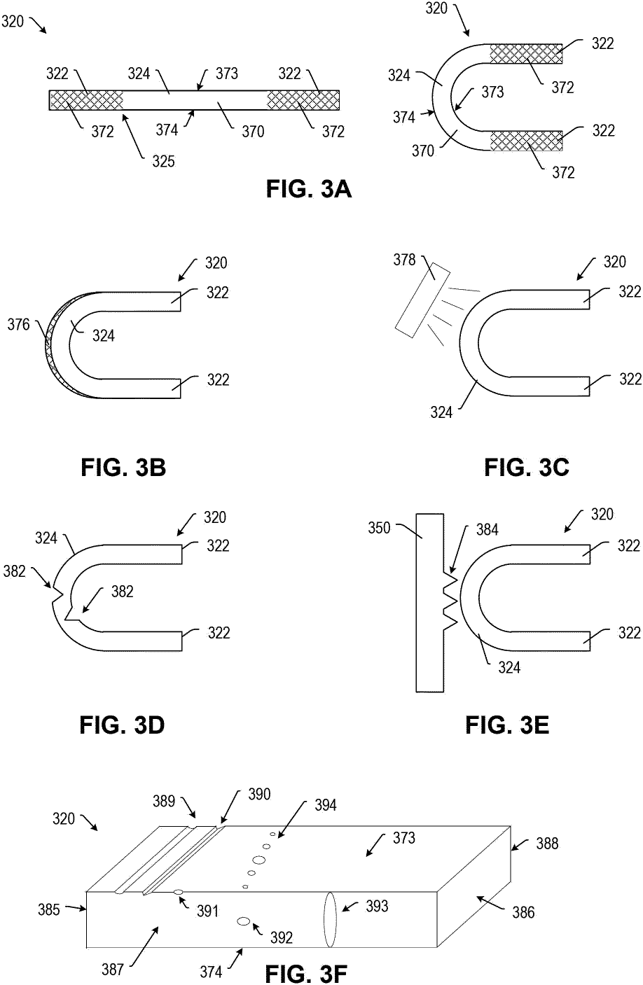

Referring to FIG. 4, an example of a method of operating a battery is shown. Method 400 may be performed by cell 102, 202, as non-limiting examples.

Method 400 includes operating a battery cell, at 402. The battery cell may have a first power unit, a first conductive member (e.g., 151, 350), and a separator. The first power unit may include or correspond to power units 110, 210. In some implementations, the first power unit may include a first busbar. Additionally, first busbar and separator may correspond to busbar 150, 152, 250, 252 and separator 120, 220, respectively. In some implementations, method 400 may further include charging or discharging a plurality of power units. For example, operating the cell may include transferring power from the plurality of power units to an electrical device.

Method 400 includes receiving a force at the battery cell, the force configured to cause a portion of a separator to break and couple, such as enable electrical coupling between, a second electrode to the first conductive member, at 404. Additionally, or alternatively, breaking of the separator may enable the first electrode to be coupled to the second electrode via the first conductive member. The portion of the separator may include or correspond to first end portions 124, 224 or second end portions 126, 226. In some implementations, the second electrode may correspond to second electrode 114, 214 and the first conductive member may correspond to first conductive member 151. The coupling of the second electrode to the first conductive member may cause an electrical short. For example, coupling the second electrode to the first conductive member may include transferring electrical current from the second electrode to the first conductive member (e.g., via a second connector and/or a first connector). Method 400 may further include conducting heat, by the first conductive member and/or the first busbar, during the electrical short. In some implementations, receiving a force corresponds to an impact with another object or the ground.

Thus, method 400 mitigates the risk of combustion or explosion of the battery cell. For example, the second electrode and/or the second current collectors coupled to the first conductive member may discharge and conduct heat from one or more power units safely without a focused short or thermal runaway. In this way and others, separator may enable the cell to evenly discharge in the event of an impact.

Some implementations of the present disclosure include a method of making a battery cell (e.g., 102, 202). Some such methods may include forming and/or assembling the separator. The separator may correspond to separator 120, 220, 320. In some implementations, forming the separator including striping two or more materials (e.g., 370, 372 as shown in FIG. 3A) such that one material is aligned with end portions of the separator and one other material aligns with body portions of the separator. End portions and body portions may include or correspond to end portions 124, 126, 224, 226, 324 and body portions 122, 222, 322, respectively.

In some implementations, assembling the separator may include folding the separator over a plurality of electrodes. Some implementations (e.g., those shown in FIGS. 3B-3D) may include coating the end portions, treating (e.g., thermal or UV treatment) the end portions, forming indentations (e.g., notches) at end portions, or combination thereof. In some such implementation, coating, treating, or notching the end portions may be performed after the cell is assembled. Some implementations (e.g., shown in FIG. 3E) of making the battery may include forming corrugations in the thermal busbar or other structure. The thermal busbar may include or correspond to first busbar 150, 250 and/or second busbar 152, 252, the first conductive member 151, or a combination thereof.

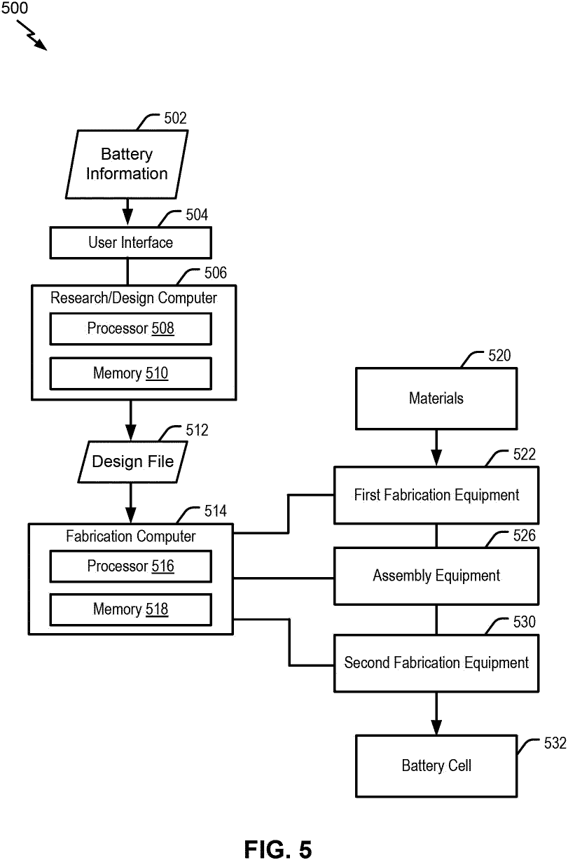

The foregoing battery cells (e.g., 102, 202) may be designed and configured into computer files stored on a computer readable media. Some or all of such files may be provided to fabrication handlers who fabricate the cells based on such files. FIG. 5 depicts an example of a system 500 for fabricating battery packs, cells, modules, or the like.

Battery information 502 (e.g., mechanical impact, electrical, and thermal management system information, battery cell information, battery pack information, and/or separator information) is received at a research/design computer 506. Battery information 502 may include design information representing at least one physical property of a battery such thermal management system 100, 200, battery cell 102, 202, or battery pack. For example, battery information 502 may include measurements of fracture toughness of a separator (e.g., 120, 220, 320), brittle features of a cell (e.g., shown in FIGS. 4A-4E), cell geometry, and/or the like, that are entered via a user interface 504 coupled to research/design computer 506. Research/design computer 506 includes a processor 508, such as one or more processing cores, coupled to a computer readable medium (e.g., a computer readable storage device), such as a memory 510. Memory 510 may store computer readable instructions that are executable to cause processor 508 to transform battery information 502 into a design file 512. Design file 512 may include information indicating a design for an battery cell (e.g., 102, 202), battery pack, or other component of thermal management system. Design file 512 may be in a format that is usable by other systems to perform fabrication, as further described herein.

Design file 512 is provided to a fabrication computer 514 to control fabrication equipment during a fabrication process for material 520. Fabrication computer 514 includes a processor 516 (e.g., one or more processors), such as one or more processing cores, and a memory 518. Memory 518 may include executable instructions such as computer-readable instructions or processor-readable instructions that are executable by a computer, such as processor 516. The executable instructions may enable processor 516 to control fabrication equipment, such as by sending one or more control signals or data, during a fabrication process for materials 520. In some implementations, the fabrication system (e.g., an automated system that performs the fabrication process) may have a distributed architecture. For example, a high-level system (e.g., processor 516) may issue instructions to be executed by controllers of one or more lower-level systems (e.g., individual pieces of fabrication equipment). The lower-level systems may receive the instructions, may issue sub-commands to subordinate modules or process tools, and may communicate status back to the high-level system. Thus, multiple processors (e.g., processor 516 and one or more controllers) may be distributed in the fabrication system.

The fabrication equipment may include first fabrication equipment 522, assembly equipment 526, and second fabrication equipment 530, as illustrative, non-limiting examples. First fabrication equipment 522 is configured to form components of a battery cell (e.g., 102, 202), such as separator 120, 220, 420 from materials 520. The separator may be formed by extruding, laminating, pressing, molding, injecting, etching cutting, milling, or the like. In some implementations, first fabrication equipment 522 may form one or more other components of the cell such as first current collector 130, 230, second current collector 140, 240, first busbar 150, 250, or second busbar 152, 252. Assembly equipment 526 is configured to assemble the fabricated pieces into one or more devices. For example, separators may be assembled with other components to from the battery cell. In some implementations, assembly equipment 526 may be configured to fold the separator over a cathode and an anode of power units 110, 210 to form the cell. Second fabrication equipment 530 is configured to fabricate one or more components of the cell after assembly. For example, second fabrication equipment 530 may form one or more brittle features of the cell (e.g., as described in FIGS. 3A-3E). Additionally, or alternatively, second fabrication equipment 530 may be configured to include one or more power units into a container (e.g., 160), to couple the one or more power units to one more electrical connections (e.g., 204), or a combination thereof. In some implementations, after operation of second fabrication equipment 530, formation of battery cell 532 is compete. Although described as forming a battery cell, in other implementations, second fabrication equipment or additional fabrication equipment may couple multiple battery cells to form a battery subpack. Additionally, although the fabrication equipment has been described as including first fabrication equipment 522, assembly equipment 526, and second fabrication equipment 530, identification of such equipment is for illustration only and should not be considered limiting. For example, the fabrication equipment may include fewer pieces of equipment, more pieces of equipment, and/or different pieces of equipment to form a battery subpack.

System 500 enables fabrication of one or more battery cells, or battery packs, as described herein. For example, the one or more battery cells may include a separator having one or more brittle features as described in mechanical impact/electrical/thermal management system 400. Accordingly, system 500 may advantageously form the batteries to provide a battery cell that operates to uniformly discharge in a safe manner upon receipt of a force, thus preventing focused shorts and thermal runaway. Additionally, system 500 may enable assembly of the cells without damage to the separator while still maintaining brittleness along discharge portions (e.g., end portions, 124, 126, 224, 226) to fracture upon a high-stress impact.

Although aspects of the present application and their advantages have been described in detail, it should be understood that various changes, substitutions and alterations can be made herein without departing from the spirit and scope of the disclosure as defined by the appended claims. Moreover, the scope of the present application is not intended to be limited to the particular implementations of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding implementations described herein may be utilized. Accordingly, the appended claims are intended to include within their scope such processes, machines, manufacture, compositions of matter, means, methods, or steps.

The above specification provides a complete description of the structure and use of illustrative configurations. Although certain configurations have been described above with a certain degree of particularity, or with reference to one or more individual configurations, those skilled in the art could make numerous alterations to the disclosed configurations without departing from the scope of this disclosure. As such, the various illustrative configurations of the methods and systems are not intended to be limited to the particular forms disclosed. Rather, they include all modifications and alternatives falling within the scope of the claims, and configurations other than the one shown may include some or all of the features of the depicted configurations. For example, elements may be omitted or combined as a unitary structure, connections may be substituted, or both. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one configuration or may relate to several configurations. Accordingly, no single implementation described herein should be construed as limiting and implementations of the disclosure may be suitably combined without departing from the teachings of the disclosure.

The previous description of the disclosed implementations is provided to enable a person skilled in the art to make or use the disclosed implementations. Various modifications to these implementations will be readily apparent to those skilled in the art, and the principles defined herein may be applied to other implementations without departing from the scope of the disclosure. Thus, the present disclosure is not intended to be limited to the implementations shown herein but is to be accorded the widest scope possible consistent with the principles and novel features as defined by the following claims. The claims are not intended to include, and should not be interpreted to include, means-plus- or step-plus-function limitations, unless such a limitation is explicitly recited in a given claim using the phrase(s) “means for” or “step for,” respectively.

1. A battery cell comprising:
a first power unit comprising:
a first electrode including a first current collector coupled to a first conductive member; and
a second electrode; and
a separator comprising:
a first portion interposed between the first electrode and the second electrode; and
a second portion positioned between the second electrode and the first conductive member; and
wherein the second portion of the separator is configured to break responsive to receipt of a force to the battery.

2. The battery cell of claim 1, wherein:
the first conductive member includes a first busbar coupled to the first current collector, a portion of the first current collector, a surface of or coating on a container of the battery cell, or a combination thereof; and
the second electrode is configured to be coupled to the first conductive member to create an electrical short when the second portion of the separator is broken.

3. The battery cell of claim 2, wherein the first conductive member is configured to conduct and distribute heat during the electrical short.

4. The battery cell of claim 1, wherein the second portion of the separator has a fracture toughness (K_{Ic}) between 0.2 to 5 MPa·m^{½}.

5. The battery cell of claim 4, wherein :
the first electrode comprises
a first graphite layer;
a second graphite layer; and
a first portion of the first current collector is interposed between the first graphite layer and the second graphite layer.

6. The battery cell of claim 5, wherein the second electrode comprises:
a first cathode layer;
a second cathode layer; and
a second current collection including a first portion interposed between the first cathode layer and the second cathode layer.

7. The battery cell of claim 1, wherein the battery comprises a lithium-ion battery.

8. The battery cell of claim 1, wherein:
the first current collector comprises a first portion and the first conductive member extending away from the first portion; and
the first conductive member of the first current collector extends in a direction substantially parallel to a length of a first busbar configured to distribute heat.

9. The battery cell of claim 8, further comprising:
a second current collector coupled to the second electrode; and
a second busbar coupled to the second current collector and configured to distribute heat from the second current collector.

10. The battery cell of claim 9, wherein:
the first busbar and the first electrode comprise copper; and
the second busbar and the second electrode comprise aluminum.

11. The battery cell of claim 9, further comprising:
a second power unit comprising:
a third electrode including a third current collector; and
a fourth electrode including a fourth current collector; and wherein:
the separator comprises a third portion interposed between the third electrode and
the fourth electrode and a fourth portion positioned between the fourth electrode and the first busbar;
the first busbar is coupled to the third current collector; and
the second busbar is coupled to the fourth current collector.

12. A method for operating a battery, the method comprising:
charging or discharging a battery, the battery comprising:
a first power unit comprising:
a first electrode coupled to a first current collector coupled to a first conductive member; and
a second electrode; and
a separator comprising:
a first portion interposed between the first electrode and the second electrode; and
a second portion positioned between the second electrode and the first conductive member; and
receiving a force at the battery, wherein the force causes the second portion of the separator to break and couple the second electrode to the first conductive member.

13. The method of claim 12, wherein:
the battery comprises a first busbar coupled to the first current collector;
the first conductive member includes the first busbar or a portion of the first current collector;
coupling the second electrode to the first conductive member causes an electrical short; and
the first busbar conducts heat during the electrical short.

14. A battery subpack, the battery subpack comprising:
two or more batteries, at least one of the two or more batteries comprising:
a first power unit comprising:
a first electrode coupled to a first current collector, the first current collector including a conductive member; and
a second electrode; and
a separator comprising:
a first portion interposed between the first electrode and the second electrode; and
a second portion positioned between the second electrode and the first conductive member; and
wherein the second portion of the separator is configured to break responsive to receipt of a force at the corresponding battery.

15. The battery subpack of claim 14, wherein the at least one of the two or more batteries further comprises:
a second current collector coupled to the second electrode; and
a second power unit comprising:
a third electrode coupled to a third current collector; and
a fourth electrode coupled to a fourth current collector; and
wherein:
a first busbar is coupled to the first current collector and the third current collector; and
a second busbar is coupled to the second current collector and the fourth current collector.
